(19) United States
(12) Patent Application Publication
(10) Pub. No.: US 2014/0127385 A1
(43) Pub. Date: May 8, 2014

(54) Stable Aqueous Dispersions of Poorly Soluble Crystalline Nutrients

(71) Applicant: Ingredient Innovations International, Wooster, OH (US)

(72) Inventor: Scott E. Peters, Ashland, OH (US)

(73) Assignee: Ingredient Innovations International, Wooster, OH (US)

(21) Appl. No.: 14/071,094

(22) Filed: Nov. 4, 2013

Related U.S. Application Data
(60) Provisional application No. 61/722,222, filed on Nov. 4, 2012.

(51) Int. Cl. A23L 1/30

(52) U.S. Cl. CPC A23L 1/3006
USPC 426/602; 426/648

(57) ABSTRACT

A method of preparing a water nanodispersion of one or more nutritional compounds, comprising: (1) dissolving the one or more compounds in one or more lipophilic ingredients to form a dissolute; (2) combining the dissolute with a liquid and one or more nandispersion matrix ingredients to form a dispersion; and (3) reducing the size of particles in the dispersion to form the nanodispersion. Also, a water nanodispersion of one or more nutritional compound, comprising: (a) the one or more nutritional compounds; (b) one or more lipophilic ingredients in which the nutritional crystalline compound is dissolvable; and (c) one or more nanodispersion matrix ingredients.

### CROSS REFERENCE TO RELATED APPLICATIONS

This application claims priority to, and the benefit of, U.S. Provisional Patent Application Ser. No. 61/722,222 filed Nov. 4, 2012, which is incorporated herein by reference.

### FIELD OF THE INVENTION

The present invention relates to a method of preparing a water nanodispersion of one or more nutritional compounds, comprising: (1) dissolving the one or more compounds in one or more lipophilic ingredients to form a dissolute; (2) combining the dissolute with a liquid and one or more nanodispersion matrix ingredients to form a dispersion; and (3) reducing the size of particles in the dispersion to form the nanodispersion. The present invention also relates to a water nanodispersion of one or more nutritional compounds, comprising: (a) the one or more nutritional compounds; (b) one or more lipophilic ingredients in which the nutritional crystalline compound is dissolvable; and (c) one or more nanodispersion matrix ingredients.

### BACKGROUND OF THE INVENTION

Nutritional compounds, i.e., nutritional supplements, have been shown to help prevent the onset of undesirable conditions in man. These substances have been identified as either essential to human health (e.g., vitamins), or may, based on the growing compilation of studies, play a role in maintaining health.

For example, phytosterol and/or phytostanol esters have been shown to reduce serum cholesterol levels in man (mammals) upon consumption and subsequent digestion in the gut. While the mechanism for this is not completely known, scientists theorize that these compounds block absorption of cholesterol produced and released from the body through the normal hepatic function, or consumed as a component of food. In reducing serum cholesterol levels, current wisdom deduces that heart and circulatory health may be maintained by preventing such conditions as arteriosclerosis, myocardial infarction, etc.

Nutritional crystalline compounds that are very hard to solubilize, such as lutein, are currently not available in water dispersions. While micro and nano-emulsions (micelles) have been developed, the crystalline compounds can only be loaded in low quantities, and the emulsions are inherently unstable over their expected shelf life. Some of these compounds can be micronized and dispersed in oils, but are unable to be dispersed in water-based systems without ringing or precipitation of the active material. In cases where water dispersability is achieved, ingredients are used that limit the resulting products' marketability. As a result, nutritional crystalline compounds are available as either a crystalline material or a slurry of crystalline material in a vegetable oil.

Accordingly, a means to produce stable, water dispersions of hard-to-solubilize crystalline compounds is needed and desired.

### SUMMARY OF THE INVENTION

The present invention relates to a method of preparing stable water nanodispersions of one or more nutritional compounds, such as poorly water soluble crystalline nutritional compounds, for use in the food and nutritional supplement market. In some embodiments, the method of preparing the stable water nanodispersions comprises:

(1) dissolving the one or more compounds in one or more lipophilic ingredients to form a dissolute;

(2) combining the dissolute with a liquid and one or more nandispersion matrix ingredients to form a dispersion; and

(3) reducing the size of particles in the dispersion.

The present invention also relates to stable water nanodispersions of one or more nutritional compounds, such as poorly water soluble, nutritional compounds. In certain embodiments, the stable water nanodispersions comprise:

(a) one or more nutritional compounds;

(b) one or more lipophilic ingredients; and

(c) one or more nanodispersion matrix ingredients.

The present invention further relates to a water-based product comprising the nanodispersions.

The invention will be described in the Detailed Description.

### DETAILED DESCRIPTION

The present invention relates to methods of preparing stable water nanodispersions of one or more nutritional compounds, the stable water nanodispersions of one or more nutritional compounds, and water-based products comprising the nanodispersions.

The nutritional compounds of the present invention may be poorly soluble and/or crystalline. Examples may include, but are not limited to, vinpocetine, resveratrol, curcumin, lutein, lutein esters, astaxanthin, beta-carotene, phytosterols, lycopene, and any combination thereof. In the stable water nanodispersion, the nutritional compounds may be present in an amount no greater than about 5% by weight, or no greater than about 2% by weight, or no greater than about 1% by weight, or no greater than about 0.5% by weight.

The lipophilic ingredients of the present invention may aid in the dissolution of the nutritional compounds. In some embodiments, the ingredients may be food-grade. Examples of lipophilic ingredients may include, but are not limited to: (a) one or more triglycerides, such as vegetable oil, soy bean oil, safflower oil, olive oil, or medium chain triglycerides, i.e., triglycerides with mixed fatty acids of C₆ to C₁₂ lengths, such as sn-glyceryl-1-caprylate, -2-caprate, -3-caprylate, etc.; (b) one or more citrus oils (orange, lemon and lime oils); (c) one or more citrus distillates; (d) one or more essential oils, such as clove oil, oregano oil, peppermint oil, cinnamon oil, etc.; or (e) any combination thereof. In a stable water dispersion of the present invention, the lipophilic ingredients may be present up to about 40% by weight, or about 30% by weight, or about 20% by weight, or about 10% by weight.

The nanodispersion matrix ingredients may include lecithin, co-surfactants, preservatives, or any combination thereof. Examples of nanodispersion matrix ingredients may include, but are not limited to, egg, sunflower, safflower and soy lecithin, polysorbate 80, polysorbate 60, polyglycerol fatty acid esters, citric acid, potassium sorbate, decaglycerol monomyristate, quillaja extract, copolymer condensate of ethylene and propylene oxide, and any combination thereof. In a stable water nanodispersion of the present invention, the nanodispersion matrix ingredients may be present up to about 20% by weight, or about 10% by weight, or about 5% by weight.

In certain embodiments, nanodispersion matrix ingredients may include lecithin, derived from soybean or derived from egg, which contain a complex mixture of phospholipids consisting mainly of phosphatidylcholine, phosphatidylethanolamine, phosphatidylinositol, and phosphatidic acid combined with varying amounts of other substances such as triglycerides. The lecithin may be of standard grade or can be modified or refined lecithin, e.g., deoiled, hydrogenated, hydroxylated, enzyme modified, acetylated, etc.

A method of preparing the stable water nanodispersions of the present invention may encapsulate higher levels of slightly oil-soluble (lipophilic) materials than previously demonstrated in the art. The method may comprise:

(1) dissolving the one or more nutritional compound in one or more lipophilic ingredients to form a dissolute;

(2) combining the dissolute with a liquid and one or more nanodispersion matrix ingredients to form a dispersion; and

(3) reducing the size of particles in the dispersion.

The particles in the nanodispersion may be reduced to a very small size. In certain embodiments, most of the particles of the dispersion may have a size of less than about 300 nm in diameter.

The dissolution of the nutritional compound into a lipophilic material may result in a dissolute. The dissolute may be heated to a temperature of about 50-70° C., or about 55-60° C.

The dissolute may be combined with a liquid and one or more nanodispersion ingredients to form a dispersion. In certain embodiments, the liquid may be water. In some embodiments, the water may be heated to a temperature of about 50-70° C., or about 55-60° C.

In various embodiments, the dissolute and nanodispersion matrix ingredients may be added to the water. In other embodiments, the water and nanodispersion matrix ingredients may be added to the dissolute.

During or after combination of the dissolute with the water and nanodispersion matrix ingredients to form a dispersion, the dispersion may be mixed. In certain embodiments, the mixing can be achieved using a high-speed mixer.

In some embodiments, the resulting dispersion may be fluidized through a microfluidizer. The dispersion may pass through the microfluidizer more than once, e.g., twice, three times, five times, etc. The shear pressure of the microfluidizer may be up to, for instance, about 30,000 psi, or about 20,000 psi, or about 15,000 psi, or about 10,000 psi. The head pressure of the microfluidizer may be up to, for example, about 50 psi, or about 40 psi, or about 30 psi. In certain embodiments, each passing of the dispersion through the microfluidizer may differ in shear pressure and head pressure.

The stable water nanodispersions may be for use in the food and nutritional supplement market, may be stable with long shelf life, and may be infinitely dilutable. The nanodispersion may comprise:

(a) one or more nutritional compounds;

(b) one or more lipophilic ingredients; and

(c) one or more nanodispersion matrix ingredients.

The nanodispersions may facilitate the incorporation of these oil actives into water-based products such as beverages.

The nanodispersion may comprise particles of a very small size. In certain embodiments, most of the particles of the dispersion may be less than about 300 nm in diameter. In this context, “most” refers to greater than about 90% of the particles, or greater than about 80% of the particles, or greater than about 70% of the particles, or greater than about 60% of the particles, or greater than about 50% of the particles. In some embodiments, the mean particle size may be less than about 300 nm in diameter.

The water-based nutritional product may comprise a stable water nanodispersion of the present invention. The product may have active nutrient loads of up to about 5% of the final formulation, and may be physically stable at room temperature for more than a year. The water-based nutritional product may be formulated for oral administration, for example, for use in or as a beverage.

The invention will now be further described by way of the following non-limiting examples, which further illustrate the invention; such examples are not intended, nor should they be interpreted, to limit the scope of the invention.

### EXAMPLES

### Example 1

A stable water nanodispersion comprising vinpocetine was prepared according to embodiments of the present invention.

The stable water nanodispersion comprised the ingredients shown in Table 1.

TABLE 1
Components in the nanodispersion

| | Quantity | |
|---|---|---|
| Ingredients | (g) | (% weight) |
| Vinpocetine | 2.0 | 0.4 |
| Medium chain triglycerides | 98.0 | 19.6 |
| Lecithin | 20 | 4 |
| Polysorbate 80 | 12.5 | 2.5 |
| Citric acid | 2 | 0.4 |
| Potassium sorbate | 1.5 | 0.3 |
| Water | 364 g | 72.8 |

To prepare the nanodispersion, vinpocetine was dissolved in the medium chain triglycerides to form a dissolute, which was heated to 55° C. Water was heated and the dissolute, lecithin, polysorbate 80, citric acid, and potassium sorbate were added and mixed using a high-speed mixer to obtain a dispersion. This dispersion was then fluidized twice through a Microfluidizer: the first pass was at 10,000 psi shear pressure and 40 psi head pressure, and the second pass was at 15,000 psi shear pressure and 40 psi head pressure.

The resulting fluidized solution was homogeneous and could easily be incorporated into a beverage application. The physical shelf life for this product was more than one year.

### Example 2

A stable water nanodispersion comprising vinpocetine was prepared according to embodiments of the present invention.

The stable water nanodispersion and its process of making are similar to Example 1, but decaglycerol monomyristate was used as a co-surfactant instead of polysorbate 80. Thus, the stable water nanodispersion comprised the ingredients shown in Table 2.

TABLE 2
Components in the nanodispersion

| | Quantity | |
|---|---|---|
| Ingredients | (g) | (% weight) |
| Vinpocetine | 1.65 | 0.55 |
| Medium chain triglycerides | 88.35 | 29.45 |
| Lecithin | 18.0 | 6 |
| Decaglycerol monomyristate | 11.25 | 3.75 |
| Citric acid | 1.2 | 0.4 |
| Potassium sorbate | 0.9 | 0.3 |
| Water | 178.65 | 59.55 |

To prepare the nanodispersion, vinpocetine was dissolved in the medium chain triglycerides to form a dissolute, which was heated to 60° C. Water was heated to 60° C., and the dissolute, lecithin, decaglycerol monomyristate, citric acid, and potassium sorbate were added and mixed using a high-speed mixer to obtain a dispersion. This dispersion was then fluidized twice through a Microfluidizer: the first pass was at 10,000 psi shear pressure and 40 psi head pressure, and the second pass was at 15,000 psi shear pressure and 40 psi head pressure.

The resulting fluidized solution was homogeneous and could easily be incorporated into a beverage application. The physical shelf life for this product was more than one year.

While specific embodiments of the subject invention have been discussed, the above specification is illustrative and not restrictive. One skilled in the art will appreciate that numerous changes and modifications can be made to the invention, and that such changes and modifications can be made without departing from the spirit and scope of the invention.

What is claimed is:

1. A method of preparing a water nanodispersion of one or more nutritional compounds, comprising:
(1) dissolving the one or more compounds in one or more lipophilic ingredients to form a dissolute;
(2) combining the dissolute with a liquid and one or more nanodispersion matrix ingredients to form a dispersion; and
(3) reducing the size of particles in the dispersion to form the nanodispersion.

2. The method of claim 1, wherein the compound is crystalline.

3. The method of claim 1, wherein the dissolute is heated to a temperature of about 50-70° C.

4. The method of claim 1, wherein the liquid is water.

5. The method of claim 1, wherein the liquid is heated to a temperature of about 50-70° C.

6. The method of claim 1, wherein the size of particles in the dispersion are reduced by passing the dispersion through a microfluidizer one or more times.

7. The method of claim 6, wherein the dispersion is passed through the microfluidizer at a shear pressure of no greater than about 30,000 psi.

8. The method of claim 6, wherein the dispersion is passed through the microfluidizer at a head pressure no greater than about 50 psi.

9. A water nanodispersion of one or more nutritional compounds, comprising:
(a) the one or more nutritional compounds;
(b) one or more lipophilic ingredients in which the nutritional crystalline compound is dissolvable; and
(c) one or more nanodispersion matrix ingredients;
wherein the nanodispersion comprises particles having a mean size of less than about 300 nm in diameter.

10. The water nanodispersion of claim 9, wherein the one or more nutritional compounds are selected from the group consisting of vinpocetine, resveratrol, curcumin, lutein, lutein esters, astaxanthin, beta-carotene, phytosterols, lycopene, and any combination thereof.

11. The water nanodispersion of claim 9, wherein the one or more nutritional compounds are present in an amount no greater than about 5% by weight.

12. The water nanodispersion of claim 9, wherein the one or more lipophilic ingredients are selected from a group consisting of one or more triglycerides, one or more citrus oils, one or more citrus distillates, one or more essential oils, and any combination thereof.

13. The water nanodispersion of claim 12, wherein the one or more triglycerides are selected from the group consisting of vegetable oil, soy bean oil, safflower oil, olive oil, medium chain triglycerides, and any combination thereof.

14. The water nanodispersion of claim 12, wherein the one or more citrus oils are selected from the group consisting of orange oil, lemon oil, lime oil, and any combination thereof.

15. The water nanodispersion of claim 12, wherein the one or more essential oils are selected from the group consisting of clove oil, oregano oil, peppermint oil, cinnamon oil, and any combination thereof.

16. The water nanodispersion of claim 9, wherein the one or more lipophilic ingredients are present in an amount no greater than about 40% by weight.

17. The water nanodispersion of claim 9, wherein the one or more nanodispersion matrix ingredients comprise co-surfactants, preservatives, or any combination thereof.

18. The water nanodispersion of claim 17, wherein the one or more nanodispersion matrix ingredients are selected from the group consisting of egg, sunflower, safflower and soy lecithin, polysorbate 80, polysorbate 60, polyglycerol fatty acid esters, citric acid, potassium sorbate, decaglycerol monomyristate , quillaja extract, copolymer condensate of ethylene and propylene oxide, and any combination thereof.

19. The water nanodispersion of claim 9, wherein the one or more nanodispersion matrix ingredients are present in an amount no greater than about 20% by weight.

20. A water-based nutritional product comprising the water nanodispersion of claim 9.
